(19) United States
(12) Patent Application Publication
(10) Pub. No.: US 2006/0139690 A1
(43) Pub. Date: Jun. 29, 2006

(54) Information processing device and job transfer control method

(75) Inventor: Takashi Yagita, Yokohama-shi (JP)

Correspondence Address: FITZPATRICK CELLA HARPER & SCINTO, 30 ROCKEFELLER PLAZA, NEW YORK, NY, 10112, US

(73) Assignee: CANON KABUSHIKI KAISHA, Tokyo (JP)

(21) Appl. No.: 11/357,042

(22) Filed: Feb. 21, 2006

Related U.S. Application Data
(63) Continuation of application No. PCT/JP05/10869, filed on Jun. 14, 2005.

(30) Foreign Application Priority Data
Jun. 16, 2004 (JP) 2004-178402

(51) Int. Cl. G06F 3/12

(52) U.S. Cl. 358/1.15

(57) ABSTRACT

In a method for controlling transfer of print jobs by an information processor in a print system configured by information processors and an image forming apparatus, multiple print jobs based on application data are received, and the multiple received print jobs are grouped and managed as grouped jobs. Control is performed so that the multiple print Jobs (print job data) are transferred to the image forming apparatus in one session with the use of a predetermined printing protocol after spooling of the multiple print jobs is completed.

### TECHNICAL FIELD

The present invention relates to grouping of jobs in a print system.

### BACKGROUND ART

Conventionally, various kinds of protocols for various layers have been devised as a method for sending print job data to a printer device. In general, when printing is performed by a printer device, the printer device receives print jobs sent from a host and prints the print jobs in the order of accepting them.

Meanwhile, the host issues a different print request for each of documents, and therefore, print requests by another user may interrupt among the print requests for the documents. In such a case, a problem is caused that print results for that other user exist among output results.

For example, if each of hosts sends print jobs to a printer device, print results by print jobs from the hosts mixedly exist on a paper discharge tray. Therefore, a user has to sort the print results to separate his print results from print results by print jobs sent from the other hosts. In this case, there may be caused a problem that a job printed by another host is taken because of a mistake in sorting of the print results.

Thus, in consideration of such problems, mechanisms of “job grouping” to be described below are proposed in which print jobs are grouped and outputted by a host.

(1) Document Combination Method

A method in which a host combines print jobs as one document via intermediate-form data and creates print data based on the one document before sending the print jobs to a printer device, and then the host throws the created print data into the printer device.

(2) IPP (Internet Printing Protocol) Method

A method in which, when sending print jobs to a print server, a host sends a command to combine the print jobs, and the print jobs are combined and discharged by the print server or a printer device.

As a typical example of the IPP method, there is known an IPP method capable of causing a print server remotely located to perform printing or causing the print server to remotely accept printing via the Internet. In this IPP method, there is known a function of sending documents (such as documents created by Microsoft Word® and Microsoft Excel®) to a server using a multi-document declaration command (a one-job multi-document function).

In this one-job multi-document function, a Create Job command is notified to a print server (including a network card mounted on a printer) in advance; a job ID returned from the server in response to the notification is included in each job (document); and then the each job is sent to the print server.

Meanwhile, the print server creates a container corresponding to the job ID created in response to the Create Job command as well as notifying the job ID to the client side. When print jobs including the job ID are individually sent from the client, the print jobs are once stored in the container. Then, when a JobEnd command is sent, the print jobs which have been stored in the container are controlled so that outputs of other jobs do not interrupt.

(3) A Method Described in Japanese Patent Laid-Open No. 2002-182878

A method in which a print server controls the order of print jobs from hosts registered with the print server and sends print each group of print jobs to a printer device, and thereby, print jobs are discharged from the printer device as groups.

Japanese Patent Laid-Open No. 2002-182878 describes a mechanism in which documents to be printed are grouped and printed so that interruption by other print requests can be prevented.

However, according to (1) described above, among the conventional grouping methods, there intervenes a process of creating a document on the host side via an intermediate-form data, and then converting the created intermediate-form data to print data, and this presents a problem of decrease in throughput.

In (2) described above, when jobs are combined by a print server, the print server is required to be provided with a function of performing processing in accordance with IPP commands. Furthermore, there is also a problem that the print server is required to perform troublesome processing based on a printer ID. When jobs are combined by a printer device, it is necessary to take some measures such as preparing a job combination command for a printer description language, for example, and the combination command must be able to be processed on the device side. Therefore, it is necessary to add the function to a printer driver and a printer device, and the job grouping function cannot be utilized by a printer which is not appropriate for the combination command (a printer device without the job grouping function). Furthermore, in the case of combining jobs by a printer device, there are restrictions such as that printing cannot be performed until all grouped jobs have been spooled, and this presents a problem that a job with a large number of pages cannot be printed.

Furthermore, in (3) described above, when a print server controls each group of print jobs, there is a case where interruption of a print job to be printed by a device, from a host which is not managed by the print server or another print server occurs, and thereby grouping of print jobs is not correctly performed, or a case where grouping cannot be realized without the print server.

It is possible to collectively send electronic files by performing communication in conformity with an FTP (File Transfer Protocol). However, when this is applied to a print system, a user has to perform operations to create individual print data files from individual application data with the use of a printer driver and the like, and send the created print data files to a printer apparatus using the FTP. Therefore, and it is not practical because of such troublesome works.

An object of the present invention is to enable grouping of print jobs in a simple configuration.

Another object of the present invention is to enable achievement of the print job grouping function even in an environment without a print server or in a print system environment where a printer driver and a printer device are not implemented with the job grouping function.

### DISCLOSURE OF INVENTION

In order to achieve the above object, a job transfer control method according to the present invention is a method for controlling transfer of print jobs by an information processor in a print system including the information processors and an image forming apparatus, the method comprising the processes of: receiving print jobs based on application data; grouping the print jobs received at the receiving process and managing the print jobs as grouped jobs; and controlling the print jobs to be transferred to the image forming apparatus in one session with the use of a predetermined printing protocol after spooling of the print jobs is completed.

Furthermore, an information processor according to the present invention to achieve the above object has the following configuration. That is, the information processor is an information processor in a print system including information processors and an image forming apparatus, the information processor comprising: means for receiving print jobs based on application data; means for grouping the print jobs received by the receiving means and managing the print jobs as grouped jobs; means for controlling the print jobs to be transferred to the image forming apparatus in one session with the use of a predetermined printing protocol after spooling of the print jobs is-completed.

Other features and advantages of the present invention will be apparent from the description below to be made with reference to accompanying drawings.

The accompanying drawings incorporated in this application and constituting a part of this application illustrate an embodiment of the present invention and are intended to clarify the principle of the present invention together with the description below.

### BRIEF DESCRIPTION OF DRAWINGS

FIG. 1 shows the configuration of a print processing system according to this embodiment;

FIG. 2 shows the hardware configuration of a network computer according to this embodiment;

FIG. 3 illustrates print processing in this embodiment;

FIG. 4 shows relation of a print job between a print system provided by Windows® and a print job control system, in this embodiment;

FIG. 5 shows a print job information table managed by a job control service 322 in this embodiment;

FIG. 6 shows a print queue information managed by a print queue in this embodiment;

FIG. 7 is a flowchart showing a process for an application to specify grouping of jobs in this embodiment;

FIG. 8 shows an example of a jobs-to-be-grouped setting screen;

FIG. 9 shows an example of a screen for monitoring grouped jobs;

FIG. 10 is a flowchart showing a process of grouping jobs in the print queue in this embodiment;

FIG. 11 is a flowchart showing a process of grouping jobs at an output port in this embodiment;

FIG. 12 is a flowchart showing an operation flow in the case of performing substitute printing in this embodiment;

FIG. 13 shows a flow of a printing protocol for realizing a Job grouping function between a data sending section and a printer device;

FIG. 14 shows an example of the configuration of print job data;

FIG. 15 shows the configuration of a job packet transferred to the printer device; and

FIG. 16 shows a display example of a substitution notification dialog to be displayed by processing at step S1203 in FIG. 12.

### BEST MODE FOR CARRYING OUT THE INVENTION

An embodiment of the present invention will be described in detail below with reference to accompanying drawings.

### Summary of the Embodiment

In order to accept and print a print job in a network environment, a printer device has a printing protocol based on a network protocol such as an LPR protocol, an RAW printing protocol and an IPP protocol. The printer device accepts a print job via such a printing protocol. However, when having already established a session of a printing protocol, the printer device cannot accept print job data in another session. In a print processing system of this embodiment, job grouping is realized by utilizing the characteristic of a printing protocol of a printer device.

More specifically, when grouping print jobs, an application calls start of grouping from the print system and processes print jobs to be grouped similarly to the case of normal printing. When the print processing of the jobs to be grouped has ended, the application calls termination of the grouping. The print processing system performs grouping of jobs in response to this call, and sends the grouped jobs in one session of the printing protocol of the printer device.

In this embodiment, the following methods (group modes) are provided as a method for performing sending in one session in the grouping function.

[Group Mode 1]

A method in which a session is started when the application starts an instruction to group jobs. According to the method of the group mode 1, the first page is printed fast. That is, FirstPrint is executed fast.

[Group Mode 2]

A method in which a session is started when spooling of one of grouped jobs is completed. According to the method of the group mode 2, time required for holding a session is reduced in comparison with the method of the group mode 1, and thereby the possibility of keeping other hosts from printing can be reduced. Furthermore, FirstPrint is executed fast.

[Group Mode 3]

A method in which a session is started after spooling of jobs of all hosts have been completed. According to the method of the group mode 3, even after printing of grouped job is instructed, operations such as deletion of a desired job from the grouped jobs can be performed. In the group modes 1 and 2, even if the application fails in grouping of jobs, the first job is printed, that is, wasteful printing is caused. In the group mode 3, however, such a trouble can be prevented.

In this embodiment, it is possible to select a desired group mode based on the condition of jobs to be printed or the condition of a print system. For example, if the first job among jobs to be grouped is a small job which requires a short time for spooling, it is possible to output the first page from a printer quickly by using the method of the groups mode 1 or 2. That is, a method which attached importance to FirstPrint can be performed.

In the methods of the group modes 1 and 2, a session is established with a printer device during spooling, the time for which the host to perform grouping occupies the printer is long. If it is desirable to efficiently use the printer device to respond to print requests by clients, it is possible to select the group mode 3.

The print processing system of this embodiment has the following features:

(1) If an error is caused on a device, such as paper out, during printing of grouped jobs, the grouping is released, and substitute printing is performed to print each job individually.

(2) Each of grouped jobs can be treated as an individual job. Even when grouped jobs are being sent, operation of a job which has not been transferred yet can be performed. For example, suspension or deletion of a job can be performed. Deletion of a Job enables replacement of a job included in a group. It is possible to replace a job which has been once added to a group by the application.

(3) In the case where there are suspended jobs, if two or more of the suspended jobs are resumed, they are sent as grouped jobs in one session. This makes it possible to divide jobs which have been once grouped as one into groups.

<Configuration Example of a Print Processing System>

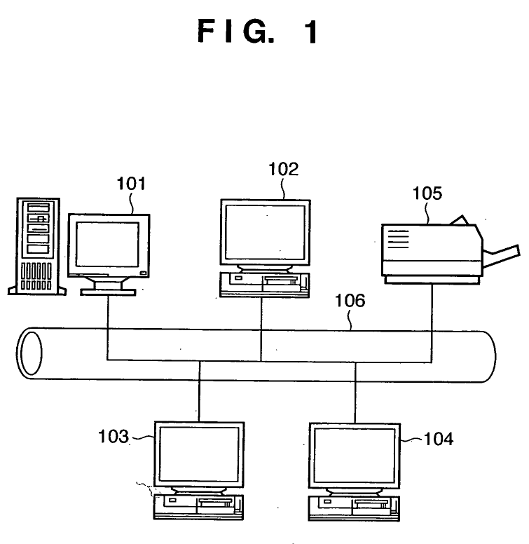

FIG. 1 is a block diagram showing the configuration of an information processing system in this embodiment. In FIG. 1, reference numerals 102, 103 and 104 denote information processors, which function as clients in a client/server system. Each client is connected to a network 106 via a network cable such as an Ethernet® cable and can execute various programs such as application programs.

A client in this system is a personal computer, and it is assumed that one or clients are connected. Each client is also referred to as “a client PC”. In the network 106, Ethernet® cables can be provided. However, the cables are not limited to Ethernet® cables, and communication cables appropriate for the RS232C interface or wireless communication can be used, for example.

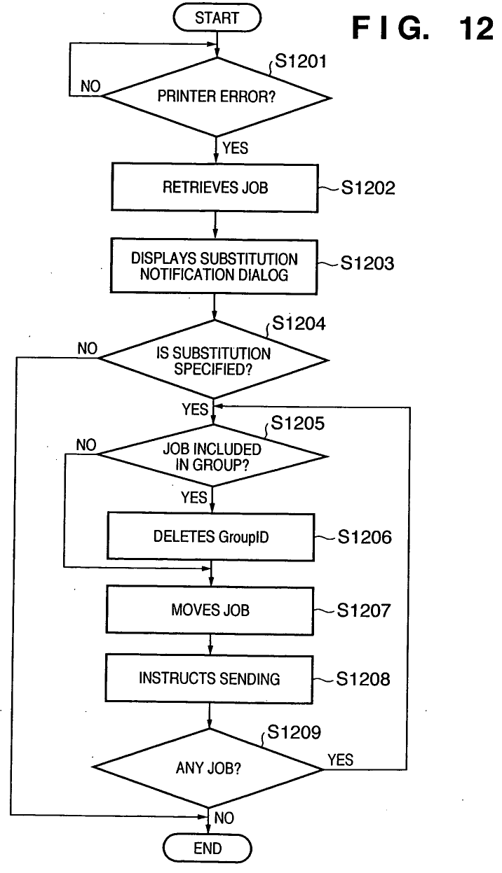

The client PC is provided with a printer driver having a function of converting print data to data in a printer language corresponding a printer. As described later with reference to FIG. 12, it is assumed that a job control print service has a virtual printing function which utilizes printing apparatuses (network printers), and the printer driver supports printer drivers in order to handle the printing apparatuses.

Reference numeral 101 denotes an information processor, which functions as a server in the client/server system. The server 101 is connected to the network 106 via a network cable, and it accumulates files to be used by clients on the network 106 and monitors the usage condition of the network 106. The server 101 also functions as a print server for managing printers connected to the network 106.

The client PC's 102 to 104 and the print server 101 of this embodiment are common information processors, and print control programs which perform different control are executably stored in the client PC's and the print server, respectively. The print server 101 can also have the functions of the client PC's 102 to 104.

The print server 101 in this embodiment further has: (1) a function of storing and printing print jobs including data to be printed, which have been sent from each of the client PC's 102 to 104; (2) a function of receiving only job information which does not include data to be printed from the client PC's 102 to 104, managing the printing order of the client PC's 102 to 104 and permitting a client PC for which a printing turn comes to send print jobs including data to be printed; (3) a function of acquiring the status of network printers or various information about print jobs to be described later and notifying the information to the client PC's 102 to 104; or the like.

Reference numeral 105 denotes a printing apparatus. In this embodiment, a network printer is used as the printing apparatus 105. Accordingly, the printing apparatus 105 is connected to the network 106 via a network interface (not shown), and it analyzes a print job including data to be printed, which is sent from a client PC, converts each page thereof to a dot image and prints the each page. Reference numeral 106 denotes a network, and the print server 101, the client PC's 102, 103 and 104, the network printer 105 and the like are connected thereto.

As the printing apparatus 105, printing apparatuses employing various printing methods can be applied, such as those employing an electrophotographic method and those employing an ink jet method. With regard to receiving print data and with regard to what mechanism printing should be performed based on the received print data, well-known techniques can be applied to realize solutions therefor, and therefore, detailed description thereof will be omitted. It is apparent that the group printing of this embodiment is not limited to a network printer but can also be realized between a host PC and a local printer.

<Example of Hardware Configuration of a Network>Computer

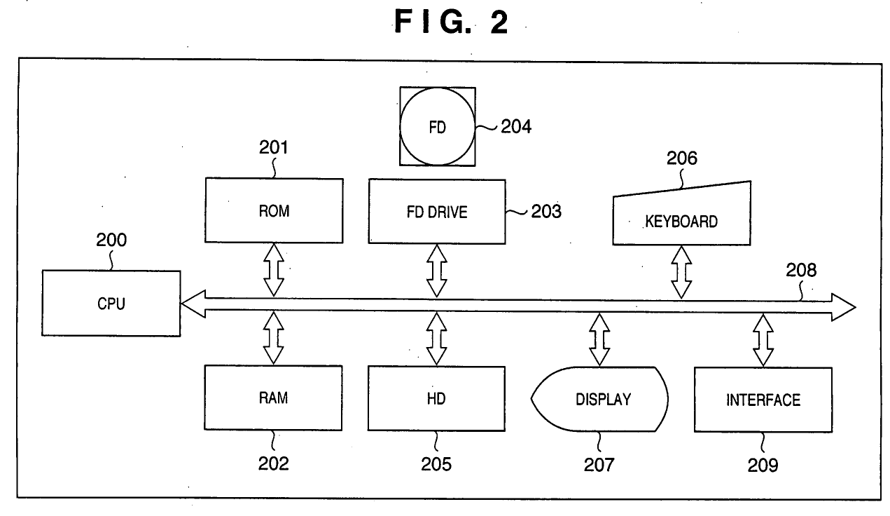

FIG. 2 is a block diagram showing the configuration of an information processor in this embodiment. The above-described print server 101 and the client PC's 102, 103 and 104, which are information processors, are assumed to have similar or the same hardware configuration. Therefore, the figure will be described as a block diagram showing configuration of a client and of a server.

In FIG. 2, reference numeral 200 denotes a CPU, which executes an application program, a printer driver program, an operating system (OS), a network printer control program and the like stored in a hard disk (HD) to be described later, and performs control for temporarily storing information, files and the like required for execution of the programs in a RAM 202.

Reference numeral 201 denotes a ROM, in which programs such as a basic I/O program and various data used for document processing such as font data and template data. Reference numeral 202 denotes a RAM for temporarily storing various data, which functions as a main memory or a work area of the CPU 200.

Reference numeral 203 denotes a drive device for realizing access to a recording medium, and in this embodiment, a flexible disk (FD) drive is used as the drive device. A program or the like recorded on an FD 204 as a recording medium can be loaded to this computer system via the FD drive 203. The recording medium is not limited to an FD, and any recording medium may be used, such as a CD-ROM, CD-R, CD-RW, PC card, DVD, IC memory card, MO and memory stick.

Reference numeral 204 denotes a flexible disk (FD), which is a recording medium with a computer readable program stored therein. Reference numeral 205 denotes an external storage device. In this embodiment, a hard disk (HD) which functions as a mass storage memory is used as the external storage device. In the hard disk 205, an application program, a printer driver program, an OS, a network printer control program, related programs and the like are stored.

A spooler for spooling a print job is located here. The spooler is a client spooler in a client PC, and a server spooler in the print server 101. In the print server 101, various tables for storing job information received from each client PC and for controlling the order are also stored in this external storage device (hard disk 205).

Reference numeral 206 denotes a keyboard as an instruction input device. The keyboard is used by a user to input and specify instructions such as a command to control a device, on a client PC, or by an operator or an administrator to do so on the print server 101.

Reference numeral 207 denotes a display, which displays a command inputted from the keyboard 206, the state of a printer and the like.

Reference numeral 208 denotes a system bus, which controls a data flow in an information processor, which is a client PC or a print server. Reference numeral 209 denotes an interface. Data is exchanged with an external apparatus via the interface 209. In this embodiment, the interface 209 realizes connection with the network 106.

In this embodiment, an example is shown in which a network printer control program and related data are directly loaded to the RAM 202 from the FD 204 and executed. In addition to this example, it is also possible to load the network printer control program to the RAM 202 from the HD 205 in which the network printer control program has already been installed, when causing the network printer control program to operate.

The medium on which the network printer control program is recorded may be a CD-ROM, CD-R, PC card, DVD or IC memory card in addition to an FD. Furthermore, it is also possible to store the network printer control program in the ROM 201 so that it forms a part of a memory map and is directly executed by the CPU 200.

Configuration by software which realizes the same functions as those of the above devices, is also possible as a substitute for the hardware devices.

The network printer control program may be also referred to simply as a print control program. In a client PC, the print control program includes programs for performing control for instructing change of the print destination of a print job or for instructing change of the order of printing. In the print server 101, the control program includes programs for controlling the order of print jobs or for notifying termination of printing of print jobs or a request to change the print destination.

The print control program for performing such controls may be separated as a module to be installed on a client PC and a module to be installed on the print server 101. Alternatively, one print control program may function as a program for a client PC or as a program for a print server according to the environment where it is executed. Alternatively, it is also possible to install the module having functions for a client PC and the module having functions for a print server on one computer together and cause them to perform concurrent operations or time-division pseudo-parallel operations.

The control program may be realized by the module installed on a client and the module installed on the print server in cooperation with each other, or may be realized by the module installed on a client or on the print server independently.

<Example of Software Configuration in the Print>Processing System

Here, the technical meanings of terms used in this embodiment will be described. Such a driver as interprets a rendering command (generally referred to as DDI (Device Driver Interface) or GDI (Graphic Device Interface)) outputted via a graphic engine of an OS such as Windows® in response to a print instruction by an application, generates data in a printer description language (PDL) and causes a printer to output it (the data) is generally referred to as “a printer driver”, and the printer is generally referred to as “a device”.

The OS is not limited to Windows®. It goes without saying that any OS that is provided with a rendering command is applicable.

Combination of a printer driver and a printer output port (port monitor) may be sometimes referred to as “a printer”, which is differentiated from a printer as a device.

Next, description will be made on the flow of print jobs (including a rendering command issued from an application for printing a document and the like) to be processed by DOMS (Document Output Management Service) in the client/server system of this embodiment.

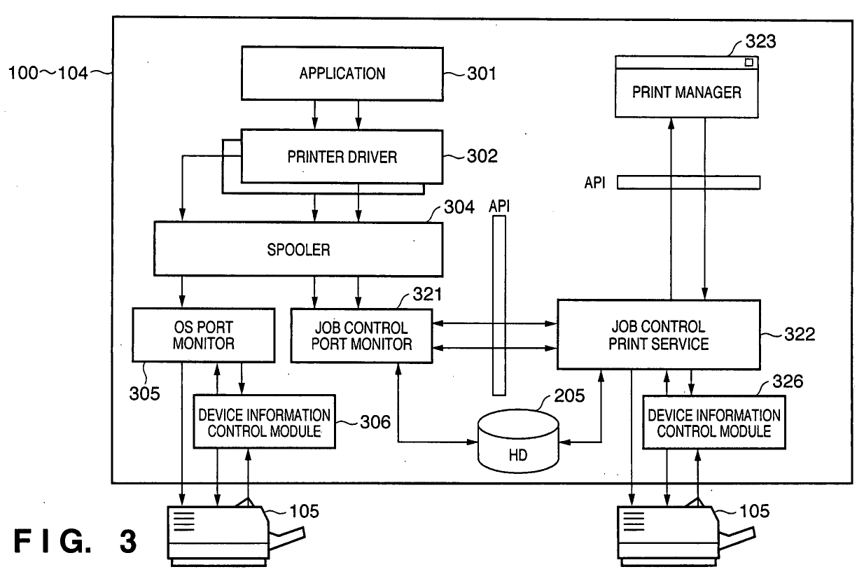

FIG. 3 illustrates the flow of print jobs in a print processing system. Generally, when a user instructs printing, from a client PC, an application program generates a series of rendering commands via the graphic engine of the OS, and the rendering commands are passed to the spooler of the OS via a printer driver. Then, the spooler of the OS takes a procedure for passing print job data to a port monitor selected by the user when he instructed printing to cause the print job data to be sent to a printer device.

As an example of a user interface for setting the port monitor described above, a setting screen for setting properties of a printer installed in a Windows® can be used.

In this embodiment, the user specifies a port monitor 321 for a print job control system (hereinafter abbreviated as “a job control port monitor”) in advance and instructs printing. An application program 301 causes a series of rendering commands to be generated via the graphic engine of the OS. The rendering commands generated via the graphic engine of the OS are then passed to a printer driver (PDL driver) 302.

Having received the rendering commands generated via the graphic engine of the OS, the printer driver 302 generates data in a page description language to be printed by a device and outputs the data to a spooler 304. The generated data is not sent to a port monitor 305 as conventionally done but is sent to a job control port monitor 321 as print job data destined to the printer device 105. Print setting information, such as paper size and staple specification, set via the user interface provided by the printer driver 302 is also sent to the job control port monitor 321.

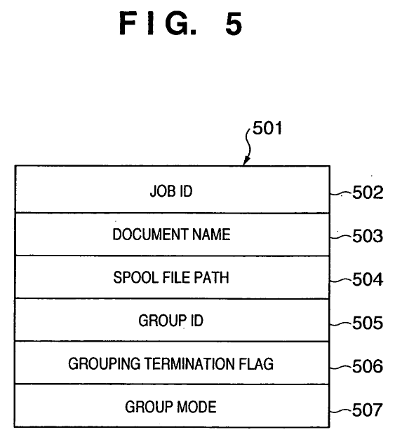

The job control port monitor 321 does not send the print job data to the printer device 105 but passes it to a print service for a print job control system 322 (hereinafter abbreviated as “a job control print service). Specifically, the job control port monitor notifies a spool file path 504 (FIG. 5) to the job control print service 322. The job control print service 322 receives a stored print job based on the spool file path 504. The job control print service 322 receives the print job data from the job control port monitor 321, and sends the received print job data to a corresponding printer device. When reprinting is performed on a particular printer device by the job control print service 322, the print job is read from the HD 205 again based on the spool file path 504 which has been notified before, and the read print job is transferred to the printer device.

A print manager for a print job control system 323 (hereinafter abbreviated as “a print manager”) is a program for checking the condition of a print job within the job control print service 322 and displaying the checked content on a graphic user interface, or providing a user interface for a user to operate the print job. The print manager 323 exchanges information or instructions with the job control print service 322 via software interface (API: Application Program Interface) of the job control print service 322. The exchange via the API may be by means of polling to the job control print service 322 or by means of event notification from the job control print service 322. A more detailed process is as follows: the print manager 323 issues an event for which a destination device is specified, to the job control print service 322, and the job control print service 322 monitors the status of the device based on the event and notifies the monitoring result to the print manager 323.

Device information control modules 306 and 326 perform communication with the printer device 105 to obtain information about print jobs in each device and the operation condition of the each device or perform operations. The obtained information can be passed to the job control print service 322.

<Relation Between a Windows® Print System and a Print Job>

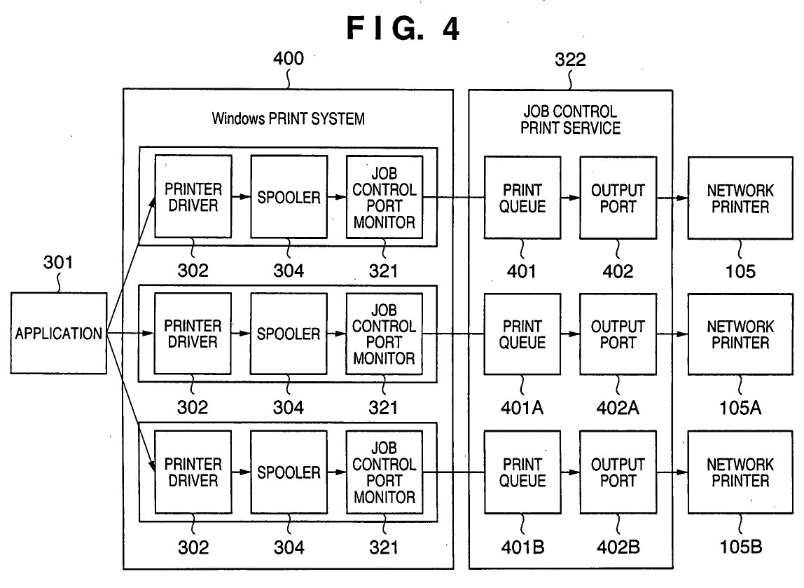

Next, more detailed description will be made on a print job in a print system provided by Windows® and the print job in the print job control system, and on the summary of processing, with reference to FIG. 4.

Conceptually, each network printer 105 is provided with the printer driver 302, the spooler 304 and the job control port monitor 321, as shown in FIG. 4. When the OS is Windows®, these components may be referred to as a Windows® print system 400. Combination of the printer driver 302 and an output port 402 corresponds to one logical printer.

The job control print service 322 includes the same number of print queues 401, 401A and 401B and output ports 402, 402A and 402B as the number of network printers 105, 105A and 105B which are output devices. Communication information, such as the IP address of a corresponding printing apparatus or a name to be used for name resolution (DNS: Domain Name System), is associated with the output port. A destination of sending a job is identified based on the IP address or the name, and the job is sent (outputted) there. In this embodiment, it is assumed that a print queue is set for each network printer which is a physical apparatus, but this is not limiting. A print queue may be set for each logical printer. That is, it is possible to set one logical printer for network printers and set one print queue for the logical printer. Reversely, it is also possible to set logical printers for one network printer and set a print queue for each of the logical printers.

When transferring a print job to a network, the application 301 specifies a print queue corresponding to a network printer having a printing function to issue a print instruction. When a print job generated by the printer driver 302 based on this print instruction is passed to the job control print service 322 from the job control port monitor 321, job information (to be described later) about the print job is first held by the print queue 401. Then, the print job is sent to the network printer 105.

<Description on Print Job Control by the Print Processing System>

Next, description will be made on a process in which the application 301 groups print jobs, and then the job control print service 322 transfers the jobs which have been grouped (hereinafter, also referred to as grouped jobs) to the printer device 105 without cutting connection with the printer device 105. First, description will be made on a print job information table managed by the print queue 401 of the job control print service 322. The print queue 401 may be also called a job management section because it manages the print job information table.

FIG. 5 shows a configuration example of the print job information table managed by the print queue 401 which is a job management section. A print job information table 501 in this embodiment is created by the print queue 401 when print job data is outputted to the job control print-service 322 from the job control port monitor 321.

If the print job data is grouped jobs to be described later, the print job information table 501 is issued for each of print job data constituting the grouped jobs.

In the print job information table 501 shown in FIG. 5, a job ID 502 is any ID assigned for a print job information table managed by the print queue 401 and used as an ID for identifying a print job. A document name 503 is a name of a document (document file) to be printed by the application 301, and it is notified to the print queue 401 from the job control port monitor 321 when print job data is sent to the job control print service 322 from the job control port monitor 321. A spool file path 504 is a file path of the print job data sent to the job control print service 322 from the job control port monitor 321 and stored in the HD 205. It is used as information identifying a storage location of a file.

A group ID 505 is an ID issued, when the application 301 specifies grouping of files to be printed, by the print queue 401 for the group. It is possible to identify each individual print job data as grouped jobs by the group ID 505, and it is also possible to manage print jobs received via the application 301 as grouped jobs by the group ID 505. A group end flag 506 is a flag indicating the last print job data among grouped jobs. This flag is attached to a print job to be grouped last among print jobs specified to be grouped.

A group mode 507 indicates a mode of the job grouping function, and it can be specified when the application 301 specifies grouping of jobs. In this embodiment, any of the group modes 1 to 3 can be specified as described in <Summary of the embodiment>, and information indicating which group mode is specified is recorded as the group mode 507.

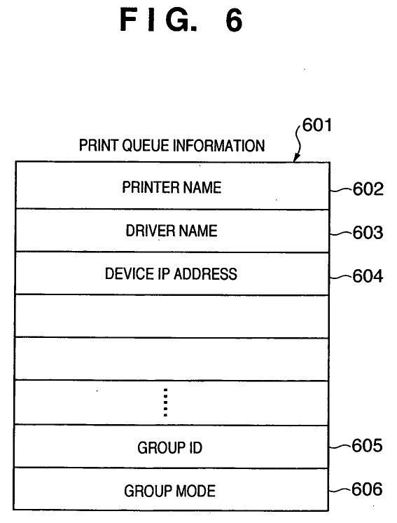

FIG. 6 shows print queue information for deciding the operation of a print job accepted by the print queue 401. The contents set in print queue information 601 includes a printer name 602, a driver name 603, a device IP address 604, a group ID 605 and a group mode 606.

The printer name 602 indicates a name of a printer object of Windows®. The printer name is a name specific to each printer object, thereby a printer object can be identified. The driver name 603 is a name of a driver set for a printer object. The device IP address 604 is the IP address of a corresponding output device (in this embodiment, a network printer). The group ID 605 is an ID for identifying a group. Based on this ID, print jobs received via the application 301 can be grouped and managed as grouped jobs. A group mode specified by the application is set as the group mode 606.

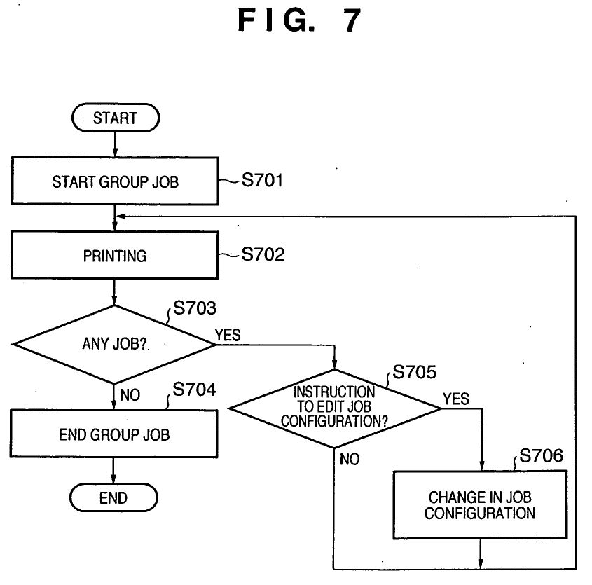

FIG. 7 is a flowchart showing a process performed when the application 301 specifies grouping of jobs.

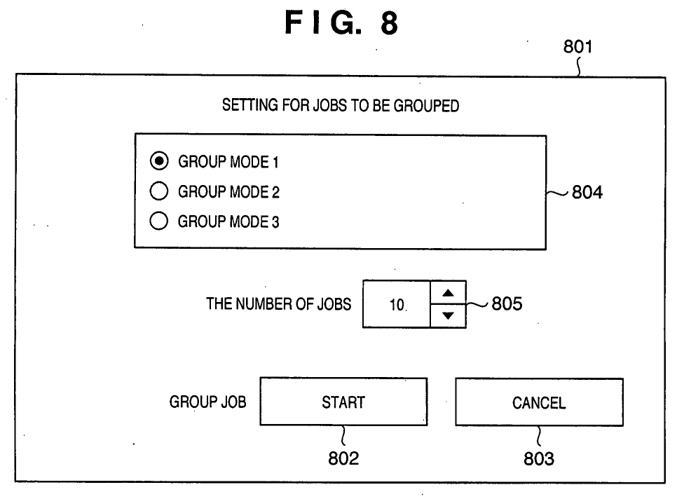

At step S701, an API (StartGroupJob) of the job control print service 322 for instructing start of grouping of jobs is called. For example, by selecting a property button of a printer to specify jobs to be grouped on a print screen provided by the application, a jobs-to-be-grouped setting screen 801 as shown in FIG. 8 is displayed on the display 207. From this jobs-to-be-grouped setting screen 801, a user can set a desired group mode and the number of print jobs to be printed as a group (804 and 805). Then, by clicking a start button 802, the grouped jobs are started. If a cancel button 803 is clicked, the process returns to a normal printing process without starting the grouped jobs. The group mode set with the use of the jobs-to-be-grouped setting screen 801 is set as the group mode 606 in the print queue information 601. If jobs are automatically issued via the server or the application 301 in response to an instruction on 802, setting for 805 is not required.

At step S702, the application 301 performs print processing similarly to the case of normal printing. At step S703, the application 301 determines whether or not there remains any job to be grouped. If there remains any such job, the process proceeds to step S705. For example, if ten jobs are specified to be grouped on the jobs-to-be-grouped setting screen 801 in FIG. 8, it is determined whether ten jobs have been printed. If the number of jobs is less than ten, then it is determined that there remains a job to be grouped.

At step S705, it is checked whether there is an instruction to perform editing of the configuration of the grouped jobs, such as replacement of a job for which print processing has been already performed as a job of the group by the application 301 at step S702. If there is an instruction to edit the configuration of the grouped jobs, then the instructed editing processing is performed at step S706, and the process returns to step S702. On the other hand, if there is not an instruction to edit the configuration of the grouped jobs at step S705, then the process immediately proceeds to step S702, where the print processing of the next job to be grouped is performed.

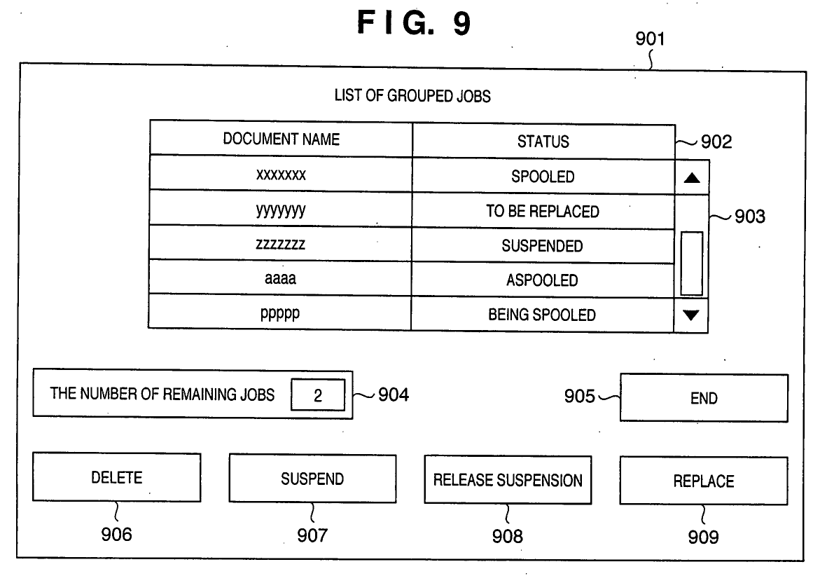

The instruction to edit the configuration of grouped jobs will be now described. By selecting the start button 802 on the jobs-to-be-grouped setting screen 801 presented at step S701, a grouped-jobs monitoring screen 901 shown in FIG. 9 is displayed. A list of grouped jobs 902 is displayed on the screen 901, on which there are listed up document names of jobs for which print processing by the application has been finished by the print operation at step S702. When all the document names cannot be displayed on the list 902, they can be checked by operating a scroll bar 903. On the list 902, there are also displayed the status of each job. For example, “Spooled” means that spooling by the job control print service 322 has been completed. In the case of the group mode 1 or 2, printing is started as soon as spooling is completed, and therefore, a job in the “Printing” status also exists.

The number of remaining jobs 904 indicates how many more jobs can be printed as jobs of the group, relative to the number of jobs set at the setting screen in FIG. 8. A termination button 905 is a button for instructing forced termination of grouped jobs. When the termination button 905 is clicked, a job specified to be printed last at that point is regarded as the final job of the group printing irrespective of whether there remains any job, and the process proceeds to step S704. The termination button 905 is used when it is desired to terminate group printing with a smaller number of jobs than the number of jobs set at the setting screen 801. However, on the contrary, there may be a case where increase the number of jobs from the set number of jobs. In order to handle such a situation, the content of the number of remaining Jobs 904 may be configured to be changeable.

Reference numerals 906 to 909 denote user interfaces for editing the configuration of grouped jobs. By specifying a desired job in the list 902 and pressing a delete button 906, the specified job can be deleted from the configuration of grouped jobs. By specifying a desired job in the list 902 and pressing a suspend button 907, the specified job can be suspended. In the suspend status, a spooled Job is not deleted but excluded from jobs to be printed as a group. By selecting a job in the suspend status and pressing a suspension release button 908 in the list 902, the suspend status is released, and the job is restored as a job in the group. Furthermore, by specifying a desired job and pressing a replace button 909 in the list 902, replacement of the specified job can be specified. The job specified to be replaced is then deleted, and a print job based on a different document, which has originally not been among the grouped jobs, is inserted into the position (the turn in the order) of the deleted job. The different job may be arbitrarily selected by the user. Alternatively, it may be a print job based on a document (application data) automatically thrown into the job control print service 322 from the server via the application 301. If there remains no job to be grouped at step S703, then the process proceeds to step S704, where an API (EndGroupjob) of the job control print service 322 for terminating the grouped jobs is called, and the grouped jobs are terminated. In response to this call, a flag indicating the final job among the grouped jobs is set as a grouping termination flag 506 of the print job information table 501.

An example of the application in the above process will be now described. For example, when grouping of ten jobs is specified by the application 301, and ten documents to be printed are acquired from a server or a database and printed, there may be a case where the document in the server or the database is changed during the print processing, or a case where the ten jobs are acquired from servers or databases.

Furthermore, there may be a case where, because of failure in acquisition of one document among documents to be acquired from a server or a database, it is required to delete jobs related to the document (jobs for which print processing has already been performed and which have been registered as jobs of a group) from the group. Even in such cases, it is possible to delete the job required to be deleted with the use of the group configuration editing described above. For example, if two of grouped jobs are required to be deleted, a total of three jobs, including the two and the job the acquisition of which has been failed, are excluded from the group, and a group of seven jobs is to be printed.

There may also be a case where it is required to replace a job before termination of grouping processing because a document in a server or a database is changed, among documents to be acquired from the server or the database during the print processing being performed by the application. In this case, it is possible to delete a job for which print processing has been already performed and add a new job to the group, for example, via a database or a server different from the application 301 or via the application 301 to achieve replacement.

As for a document with a large number of pages, there may be a case where printing is performed while the document data is being acquired from a server or a database, because of the large size. In this case, it may be required to perform replacement by deleting jobs of a group, which have already been printed, and perform printing again after re-acquisition, for example, because of failure in acquisition of document data. The replacement requester (1) may request a new document from a server or a database, from the job control print service 322; (2) may cause a user to select any document via the grouped-jobs monitoring screen 901 and throw the document into the job control print service 322; or (3) may automatically throw a replacing document into the job control print service 322 via a database or a server.

Furthermore, there may be a case where the condition of a server or a database changes during print processing of grouped jobs being performed by the application, and ten grouped jobs are required to be divided into two groups of four grouped jobs and six grouped jobs. In this case, by suspending one group of jobs and then reprinting the suspended jobs, the jobs can be printed as a separate group (this process will be described later).

With reference to FIG. 9, it has been described that various instructions are made via the grouped-jobs monitoring screen 901 to cope with a situation such as that in which change has been made in a document. However, it is also conceivable that the server and the database automatically instruct the job control print service 322 to perform the deletion, replacement, reprinting and termination processings described above, directly or via the application 301. The application 301, the server and the database may be separate hardware and software or may be the same hardware and software only if they can be logically distinguished.

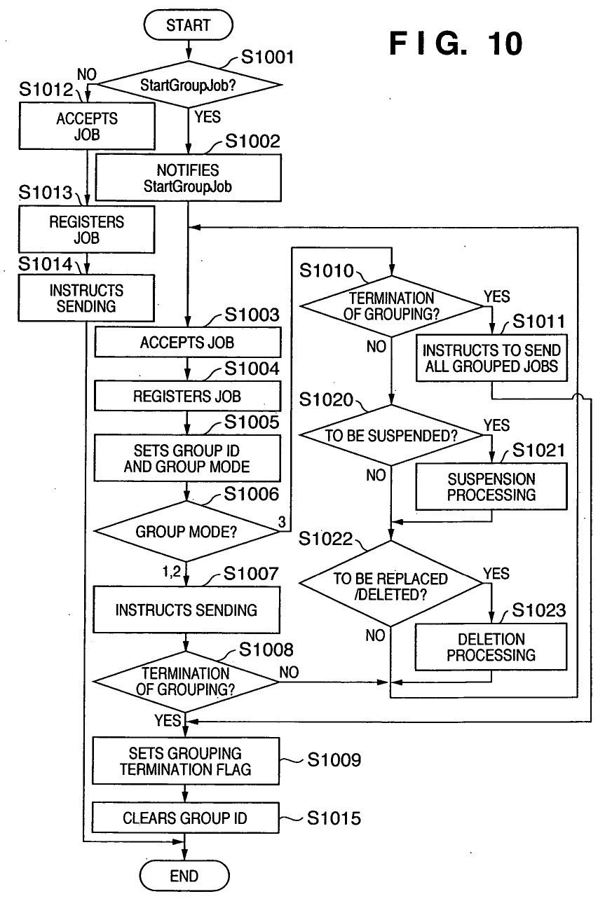

FIG. 10 is a flowchart showing a job grouping process performed by the print queue 401.

At step S1001, it is determined whether the application 301 has called the API (StartGroupJob) of the job control print service 322, which indicates start of grouping of jobs, when accepting the jobs. If StartGroupJob has been called, then the process proceeds to step S1002, where notification is made to the output port 402 to the effect that StartGroupJob has been called. A group ID is set as the group ID 605 in the print queue information 601. Group ID's are managed by the print queue 401, and an arbitrary group ID is set for each group. Furthermore, a group mode specified by the application at step S701 (setting screen 801) is set as the group mode 606 in the print queue information 601.

At step S1003, print job data is received from the job control port monitor 321. At step S1004, a print job information table 501 for the received job is created, and a job ID 502, a document name 503 and a spool file path 504 are set thereon. At step S1005, the group ID 605 in the print queue information 601 is referred to, and the value is set as the group ID 505 in the print job information table 501. The value of the group mode 606 in the print queue information 601 is set as the group mode 507 in the print job information table 501. Then, the job is registered with a print queue with the acceptance order being kept.

At step S1006, the group mode 507 in the print job information table 501 is referred to, and it is checked which group mode (in this embodiment, any of the three group modes described above) the group mode is. Then, the print jobs received at step S1003 are managed as grouped jobs. The process proceeds to step S1007 in the case of the group mode 1 or the group mode 2, and to step S1010 in the case of the group mode 3.

At step S1007, an instruction to send the jobs accepted at step S1003 is issued to the output port 402. When the sending instruction is issued, information about the job ID 502 in the print job information table 501 is also notified. At step S1005, it is determined whether the application 301 has instructed termination of grouping (EndGroupJob) at step S704 (FIG. 7). By recognizing this termination of grouping and the start of grouping at step S1001, grouped jobs can be identified and managed. If the termination of grouping has not been instructed, then it is determined that there still exists any of the grouped jobs to be sent, and the process returns to step S1003. On the other hand, if it is determined that the termination of grouping has been instructed, then the process proceeds from step S1008 to step S1009, where a grouping termination flag 506 set in the job information table for the job, and a grouping termination notification is issued to the output port. Furthermore, the process proceeds to step S1015, where the group ID 605 and the group mode 906 in the print queue information 601 are cleared, and the process ends.

If the group mode is the group mode 3 as a result of reference to the group mode 507 in the print job information table 501, the process proceeds from step S1006 to step S1010.

The group mode 3 is a mode in which a session is started after spooling of all jobs to be grouped has been completed by the job control print service 322. Accordingly, at step S1010, it is determined whether the application 301 has instructed termination of grouping at step S704. If it is determined at step S1010 that the instruction to terminate grouping has been made, then it is determined that all the jobs to be grouped have been accepted, and the process proceeds to step S1011.

At step S1011, the group ID 505 in the print job information tables 501 for the accepted jobs, an instruction to send all the jobs with the same group ID in the order of accepting the jobs is issued to the output port 702. When the sending instruction is issued, information about the job ID 502 in the print job information table 501 is also notified. In this case, if there is any job for which deletion or suspension has been specified by the application at step S1006, the job is not instructed to be sent.

On the other hand, if it is determined at step S1010 that the instruction to terminate grouping has not been made, then the process proceeds to step S1020. If suspension of a job has been specified at step S1020, then the process proceeds to step S1021, where the status of the job for which suspension is specified is shifted to the suspend status. A job in the suspend status is a job which is not sent to a printer and stops at a spooler. If deletion or replacement of a job has been specified at step S1022, then the process proceeds to step S1023, where spooled data of and related information about the job are deleted. Then, after replacement is performed, the process returns to step S1003, and processing of accepting the next job is performed. When replacement is performed, a job to be registered next is not printed in priority, but a print job based on a different document, which has originally not been among the grouped jobs is externally inserted into the position (the turn in the order) of the job deleted by the job control print service 322.

At step S1001, if it is determined that the application 301 has not called the API (StartGroupJob) of the job control print service 322 which indicates start of grouping of jobs, the job is recognized as a job for which grouping has not been specified. The process then proceeds to step S1012, where a normal print operation is performed. That is, print job data is received from the job control port monitor 321 at step S1012, and the job received at step S1012 is registered at step S1013. Here, a print job information table 501 for the job is created, and a job ID 502, a document name 503 and a spool file path 504 are set. Then, at step S1014, an instruction to send the job accepted at step S1012 is made to the output port 402, and the process ends. When the sending instruction is made, information about the job ID 802 in the print job information table 801 is also notified.

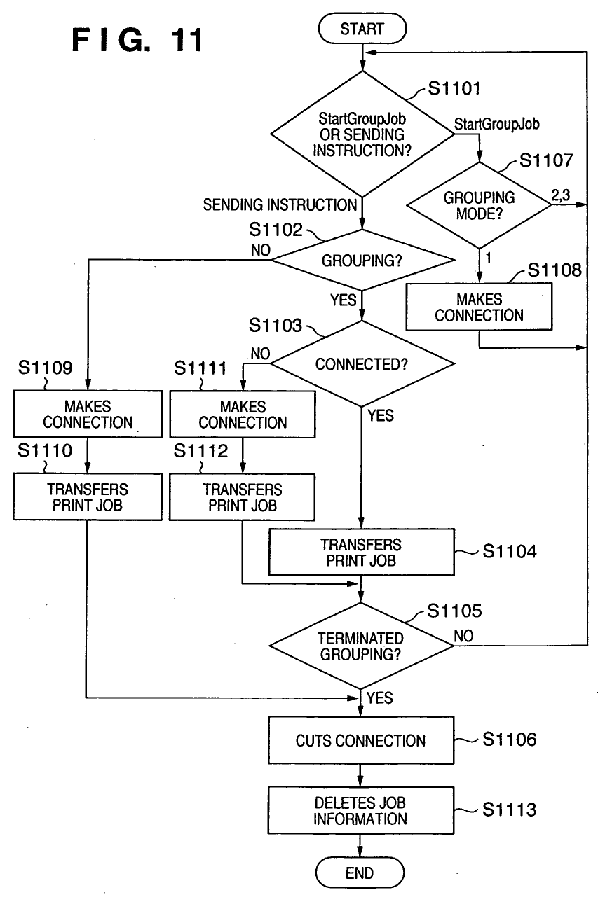

FIG. 11 is a flowchart showing a job grouping process by the output port 402.

At step S1101, it is determined whether an instruction of StartGroupJob, which has been notified at step S1002, or an issued sending instruction is received by the print queue 401. The sending instruction to be received here may be a sending instruction issued at any of steps S1007, S1011 and S1014 or a sending instruction issued by the user or the application instructing reprinting of a job of a group that remains unprinted due to suspension (a job of a group which has not been sent due to suspension at step S1112 or S1104 to be described later). To instruct reprinting of a job of a group which remains unprinted due to suspension, the following interface can be used. That is, by releasing suspension of a desired job and clicking a group printing resume button (not shown) on a screen similar to that shown in FIG. 9, sending of a job among grouped jobs for which suspension has been released is started. Alternatively, there may be provided an instruction button for releasing suspension of all jobs among grouped jobs, for which suspension has been set, and sending the jobs in one session.

If the instruction of StartGroupjob has been received, the process proceeds to step S1107, where the group mode 506 in the job information table 501 corresponding to the job ID specified in the sending instruction notified at step S1102 is referred to, and the group mode of the job is determined. If the group mode is the group mode 1, then the process proceeds to step S1108, where connection is made to the device IP address 604 in the print queue information 601. By this processing, a session is started immediately after start of grouping is instructed, in the case of the group mode 1. On the other hand, if it is determined at step S1102 that the group mode is the group mode 2 or group mode 3, then the process proceeds to step S1101 to wait for a sending instruction.

When a sending instruction is issued, the process proceeds from step S1101 to step S1102. At step S1102, it is determined whether grouping is specified for the job. Specifically, the group ID 505 in a print job information table 501 corresponding to the job ID specified in the sending instruction is referred to, and it is checked whether a group ID is set there. If a group ID is set, then it is assumed that grouping is specified for the job, and the process proceeds to step S1103.

At step S1103, it is checked whether the output port 402 has already connected a session for transferring grouped jobs. If connection has not been made, then connection is made to the device IP address 604 in the print queue information 601 at step S1111. At step S1112, a file of the spool file path 504 is transferred (print job transfer), and the process proceeds to step S1105 after completion of the transfer. A job for which suspension is specified is not transferred at step S1112 and S1104, and such a job remains as a suspended job. For example, if suspension has been specified for a part of grouped jobs at step S706, the jobs remain without being sent. Information about the remaining suspended jobs, such as group modes 507 or group ID's, are also left.

At step S1105, it is checked whether the grouping termination notification issued at step S1009 of FIG. 10 has been already issued. If the grouping termination notification has not been issued, then it is determined that there remains any of the grouped jobs that is to be sent, and the process proceeds to step S1101. If the grouping termination notification has been issued at step S1105, then it is determined that there remains no job of the group to be sent, and the process proceeds to step S1106. At step S1106, the session the connection of which was started at step S1111, step S1108 or step S1109 is cut, and the process ends. At step S1113, the job information tables 601 for all the grouped jobs are deleted, and the process ends.

At step S1103, if a session for transferring grouped jobs has been connected, then the process proceeds to step S1104, and the file of the spool file path 504 is transferred (print job transfer). After completion of the transfer, the process proceeds to step S1105. At step S1102, if a group ID is not set, then it is determined that the job is not a job of the group. The process then proceeds to step S1109, where normal print processing is performed. That is, connection is made to the device IP address 604 in the print queue information 601; the file of the spool file path 504 is transferred at step S1112; and the process proceeds to step S1105.

In the flowchart shown in FIG. 11, the processings at steps S1020 to S1023 are performed only in the case of the group mode 3, and the configuration of grouped jobs can be edited only in the case of the group mode 3. However, it will be apparent that, in the case of the group mode 1 or 2, it is also possible to enable editing of configuration editing, such as deletion, replacement and suspension, of a job for which spooling has been completed and which is waiting for being transferred. In this case, step S1020 can be the branch destination for “NO” at step S1008.

It is conceivable to start substitute printing if an error such as paper out occurs in a device after group printing is started as described above. However, if substitute printing is performed for a group constituted by jobs, in group printing, there is a possibility that a part of the jobs cannot be printed on a substitute device due to the paper size or the like. In this embodiment, in order to solve such a problem, control is performed as described below.

FIG. 12 is a flowchart illustrating a process for enabling substitute printing of a job of a group to be performed by a different printer when a printer error or the like has occurred in the processing by the print queue 401.

At step S1201, when the job control print service 322 detects that an error has occurred in the network printer 105, the process proceeds to step S1202. If there is not caused any printer error, the process waits at step S1201.

At step S1202, print job information tables 501 are retrieved which are registered with the print queue 401 corresponding to the network printer 105 in which the printer error has occurred. The print job information tables 501 registered with the print queue 401 are those for jobs to be printed by the network printer 105 in which the error has occurred.

At step S1203, it is notified that the printer error has occurred, based on information in the print job information tables 501 retrieved at step S1202, and a substitution notification dialog is displayed for prompting an operation user to perform substitute printing by a different printer. The document names 503 of the jobs registered with the print queue 401 and the printer name 602 in the print queue information 601 registered with the job control print service 322 are displayed in the substitution notification dialog. The operation user selects a job to be printed by a different substitute printer and the substitute printer in the substitution notification dialog. If the user does not specify substitute printing, he performs an operation of closing the dialog without performing any other operation.

At step S1204, the process waits for input of an instruction about whether or not to specify substitute printing via the substitution notification dialog 1501. In the specification of substitute printing, the job ID of job to be printed by substitute printing and the printer name of the substitute printer. If such substitute printing is instructed, the process proceeds to step S1205. If the substitute printing is not instructed, the process ends.

At step S1205, a print job information table 501 registered with the print queue 401 is retrieved based on the job ID for which substitute printing is specified, and the job for which substitute printing has been instructed is retrieved. Furthermore, it is checked whether a group ID is registered as the group ID 505 in the print job information table 501. If a group ID is registered, it means that the job belongs to a group of jobs. Therefore, at step S1206, the group ID is deleted from the print job information table 501. As a result, even if the job is moved to a substitute printer, it has been released from the grouping because the group ID 505 is not set therefor. If a group ID has not been set at step S1205, the process immediately proceeds to step S1207.

At step S1207, the print job information table 501 retrieved at step S1205 is moved to a print queue 701 corresponding to the printer name of the substitute printer specified at step S1204. Then, at step S1208, the print job information table 501 is registered with the print queue 701 of the substitute printer, and the process proceeds to step S1209. The processings at steps S1205 to S1208 are performed for all the jobs in the group being printed (step S1209).

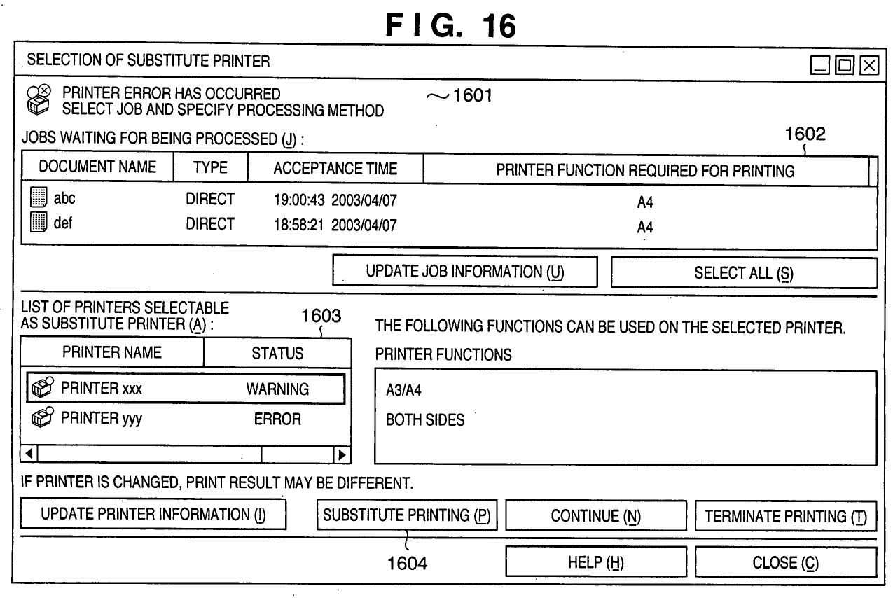

FIG. 16 shows a display example of the substitution notification dialog to be displayed by the processing performed at step S1203 of FIG. 12. This dialog notifies a user that a printer error has occurred, and the document name 503 of a job which is registered with the print queue 401 and in which the error has occurred is displayed in a list of jobs waiting for being processed 1602. Furthermore, in this dialog, the printer name 902 of the print queue 401 registered with the job control print service 322 is displayed at the position denoted by reference numeral 1601 to prompt the operation user to perform substitute printing by a different printer. By selecting a desired job in the list of jobs waiting for being processed 1602 and a desired printer in a list of substitute printers 1603 and clicking a substitute printing button 1604, an instruction to specify substitute printing is issued.

In the above description, only the job in which an error has occurred is excluded from grouped jobs to be printed by a substitute printer. However, it is also possible to cause all the jobs included in-grouped jobs to be printed by a substitute printer. In this case, all the grouped jobs are displayed in the job list 1602.

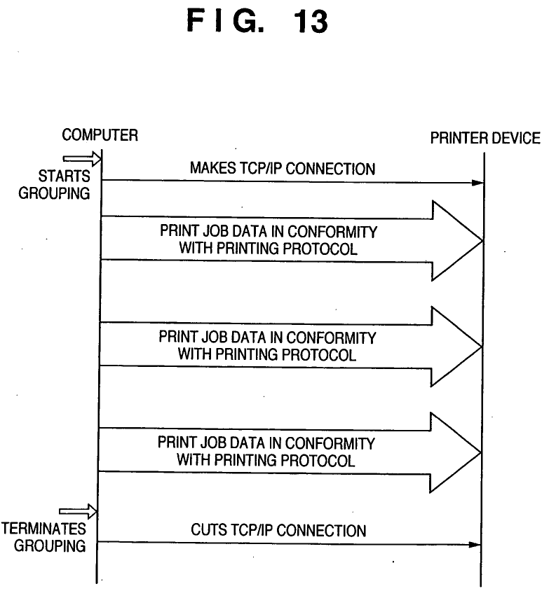

FIG. 13 shows a flow of a printing protocol for realizing a job grouping function between a data sending section and a printer device. As shown in FIG. 13, data of a plurality of print jobs is sent in one communication session.

When jobs are thrown into a standard TCP/IP port monitor installed in Windows®, connection and disconnection of a session is repeated for each print job. However, in this embodiment, it is realized to throw print jobs via a special job control port monitor 321, and thereby, print jobs can be sent in one session without disconnecting a session for each job.

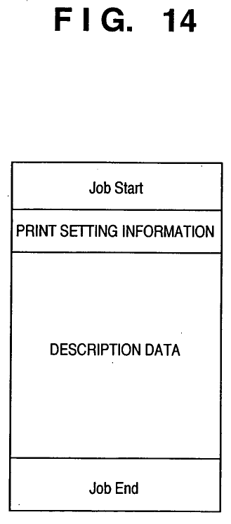

FIG. 14 shows a configuration example of print job data. As shown in FIG. 14, the print job data is configured by Job Start, print setting information, description data and Job End. The print job data in FIG. 13 corresponds to the print job data in FIG. 14.

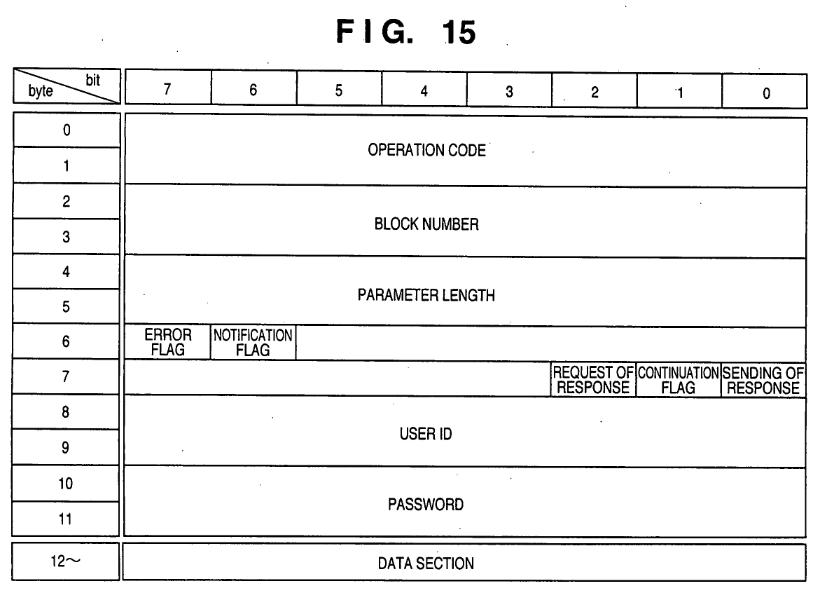

FIG. 15 shows the configuration of a job packet to be transferred to a printer device. This job packet (hereinafter, abbreviated as “a packet”) shows a packet configuration in the case where the print job data itself shown in FIG. 14 is packetized and sent, independently from the TCP/IP layer.

The vertically numbers shown in FIG. 15 indicate bytes, and horizontal numbers indicate bits of each byte. The configuration of the packet will be described below.

The operation code indicated by the 0th to 1st bytes shows an ID having a length of two bytes and indicating the function of the packet. This operation code can take the following values.
0x0201 Job start operation
0x0202 Job attribute setting operation
0x0204 PDL data sending operation
0x0205 Job termination operation

The block number indicated by the 2nd to 3rd bytes shows a number used by the packet sending side when the packet sending side requests a response, to associate the response from the receiving side with the response request by the sending side. For example, if the sending side sequentially sends packets with block numbers 1, 2 and 3, and an error packet with a block number of 2 is returned, then the sending side can identify that an error has occurred in the job packet sent second.

The parameter length indicated by the 4th to 5th bytes is an area showing the byte length of the data section and can indicate 0 to 64K bytes.

The 6th to 7th bytes are an area for indicating various flags, and each shows a value described below.

<Error Flag>

If this value is “1”, it indicates that some error has occurred in a printer device. This flag is attached to a response packet sent from the printer device to a computer.

<Notification Flag>

If this value is “1”, it indicates that the packet is not a response to the request packet from a computer but notification for notifying the computer that a printer device has something to be notified.

<Continuation Flag>

If this value is “1”, it indicates that all data cannot be included in the data section, and therefore, the remaining data is to be sent in the next packet. In this case, the same operation code and block number must be set for the-next packet as those for the previous packet.

<Reply Request>

When a computer requires a response packet from a printer device, “1” is set. If the value is “0”, it means that the request packet has been normally processed, and no response is returned. If an error occurs in the printer device, a response packet with an error flag set as “1” is invariably sent irrespective of 0/1 of the response request.

A user ID indicated by the 8th to 9th bytes and a password indicated by the 10th to 11th bytes are used for authentication performed when security restrictions are imposed on operations enabled by the request packet. This embodiment is not influenced by these.

The 12th and subsequent bytes are an area for storing additional data corresponding to the operation code. In the case of a job start operation, the execution mode for the job is described as additional data. The following are execution modes which can be specified.

<0x01: Normal Execution of a Job>

The job is added to the end of the queue for a printing apparatus as a normal job. When its turn specified by scheduling comes, print processing therefor is performed.

<0x04: Interrupting Execution of Job>

The job is treated as an interrupting job. Processing is stopped for all jobs, and printing of the job is executed in priority.

As described above, according to this embodiment, grouping of print jobs is performed on a computer (a client PC or a print server) and the jobs are sent to a printer device as grouped jobs. Thereby, even when print jobs are sent from each of computers, the printer device can receive the print jobs grouped for each computer and perform printing processing without fail.

Furthermore, when it is required to replace a part of jobs while grouping of the jobs is specified, desired jobs among jobs which have been once grouped can be released from the grouping, and thereby flexibility in grouped jobs is enhanced.

As described above, according to the above embodiment, it is possible to reliably accomplish grouping of jobs even if print jobs are sent from each of hosts to a printer device. Thus, the problem that grouping of jobs can be performed only by a printer device or a printer driver having a job grouping function or the problem.,that grouping of jobs cannot be accomplished without a printer server for controlling print jobs from client hosts can be solved.

Furthermore, in the above embodiment, in the case of performing substitute printing, by releasing specification of grouping and causing a different printer to print a job, it is possible to move the job to a printer appropriate for the characteristics of the job. Thus, the problem that, when substitute printing processing is performed because of an error such as paper out caused in any of grouped jobs on a device, a part of jobs may not be printed because of the paper size or the like on a substitute device.

Furthermore, in the above embodiment, it is possible to select a method of sending jobs to a printer after spooling all jobs to be grouped, and thereby, suspension or deletion of a job before starting sending can be accomplished. Thus, the problem is solved that, even if it is required to replace a part of jobs while grouping of the jobs is specified, the jobs once grouped cannot be released from the grouping, and therefore, the grouped jobs must be printed twice.

The present invention may be applied to a system configured by pieces of equipment (for example, a host computer, interface equipment, a reader, a printer and the like) or an apparatus configured by one piece of equipment (for example, a copying machine, a facsimile apparatus and the like).

It goes without saying that the object of the present invention can be achieved by providing a recording medium on which a program code of software for realizing the functions of the embodiment described above is recorded to a system or an apparatus, and by the computer (CPU or MPU) of the system or the apparatus reading and executing the program code stored in the recording medium.

In this case, the program code itself which has been read from the recording medium realizes the functions of the embodiment described above, and the recording medium in which the program code is stored constitutes the present invention.

As the recording medium for providing the program code, for example, a floppy® disk, hard disk, optical disk, magneto-optical disk, CD-ROM, CD-R, magnetic tape, non-volatile memory card, ROM and the like can be used.

It is not only by executing the program code read by a computer that the function of the embodiment described above can be realized. It goes without saying that the case is also included where the function of the embodiment described above is realized by an OS (operating system) or the like, which is operating on the computer, performing a part or all of the actual processing based on the instructions of the program code.

Furthermore, it goes without saying that the case is also included where the program code read from the recording medium is written in a memory provided for a feature expansion board inserted in the computer or a feature expansion unit connected to the computer, and then the function of the embodiment described above is realized by the CPU or the like provided for the feature expansion board or the feature expansion unit performing a part or all of the actual processing based on the instructions of the program code.

As described above, according to the present invention, it is possible to performing grouping of print jobs in a simple configuration. Furthermore, it is possible to realize a function of grouping print jobs even in an environment without a print server or in a print system environment where a printer driver or a printer device is not implemented with the job grouping function.

Apparently, various embodiments of the present invention can be broadly conceivable without departing from the spirit and the scope of the present invention, and therefore, it will be understood that the present invention is not limited to the above-described particular embodiment except as set forth in the claims.

### Claim of Priority

This application claims priority from Japanese Patent Application No. 2004-178402 filed on Jun. 16, 2004, the entire contents of which are hereby incorporated by reference herein.

1. A method for controlling transfer of print jobs by an information processor in a print system which includes information processors and an image forming apparatus, the method comprising the steps of:
receiving print jobs based on application data;
grouping the print jobs received at the receiving step and managing the print jobs as grouped jobs; and
controlling the print jobs to be transferred to the image forming apparatus in one session with the use of a predetermined printing protocol.

2. The job transfer control method according to claim 1, wherein timing to start the session is selectable from plural kinds of timings corresponding to plural kinds of spooling condition of the print jobs, including the timing when the spooling of the multiple print jobs is completed.

3. The job transfer control method according to claim 2, wherein one of the plural timings is timing when job grouping starts.

4. The job transfer control method according to claim 2, wherein one of the plural timings is timing when spooling of the first print job is completed.

5. The job transfer control method according to claim 1, further comprising a step of, before the session is started, excluding a desired print job among the print jobs received at the receiving step, from print jobs to be sent in the session.

6. The job transfer control method according to claim 5, wherein a desired print job is deleted at the exclusion step.

7. The job transfer control method according to claim 5, wherein the exclusion step sets a desired print job to a temporary suspend status and thereby excludes the print job from the jobs to be sent in the session; and
the method further comprises a step of releasing the temporary suspend status of print jobs, and transferring the print jobs which have been released from the temporary suspend status to the image forming apparatus in one session as grouped job.

8. The job transfer control method according to claim 1, further comprising a step of, if an error occurs in the image forming apparatus during printing of the print jobs in the session and substitute printing is instructed, releasing the grouping and transferring the print jobs to another image forming apparatus.

9. A method for controlling transfer of print jobs by an information processor in a print system which includes information processors and an image forming apparatus, the method comprising the steps of:
receiving print jobs based on application data;
grouping the print jobs received at the receiving step and managing the print jobs as grouped jobs;
excluding a specified print job among the print jobs received at the receiving step and have not been sent to an image forming apparatus, from jobs to be sent to the imaging forming apparatus; and
controlling the print jobs to be transferred to the imaging forming apparatus in one session with the use of a predetermined printing protocol.

10. An information processor in a print system which includes information processors and an image forming apparatus, the information processor comprising:
a receiving unit configured to receive print jobs based on application data;
a grouping unit configured to group the print jobs received by said receiving unit and manage the print jobs as grouped jobs; and
a controlling unit configured to control the print jobs to be transferred to the image forming apparatus in one session with the use of a predetermined printing protocol.

11. An information processor in a print system which includes information processors and an image forming apparatus, the information processor comprising:
a receiving unit configured to receive print jobs based on application data;
a grouping unit configured to group the print jobs received by said receiving unit and manage the print jobs as grouped jobs;
a excluding unit configured to exclude a specified print job among the print jobs received by said receiving unit and have not been sent to an image forming apparatus, from jobs to be sent to the image forming apparatus; and
a controlling unit configured to control the print jobs to be transferred to the image forming apparatus in one session with the use of a predetermined printing protocol.

12. A control program for causing a computer to perform the job transfer control method according to claim 1.

13. A recording medium which stores a control program for causing a computer to perform the job transfer control method according to claim 1.

14. The job transfer control method according to claim 1, wherein the controlling step is performed after spooling of the print jobs is completed.
